(19) United States
(12) Patent Application Publication
(10) Pub. No.: US 2025/0078381 A1
(43) Pub. Date: Mar. 6, 2025

(54) METHOD FOR CALCULATING AND RENDERING SMOOTH WEATHER DATA ANIMATIONS

(71) Applicant: Daniel E. Curtis, Davenport, FL (US)

(72) Inventor: Daniel E. Curtis, Davenport, FL (US)

(21) Appl. No.: 18/819,256

(22) Filed: Aug. 29, 2024

Related U.S. Application Data
(60) Provisional application No. 63/579,391, filed on Aug. 29, 2023.

(51) Int. Cl. G06T 13/80; G06T 15/80

(52) U.S. Cl. CPC G06T 13/80; G06T 15/80

(57) ABSTRACT

A method for generating smooth transitions between animated image frames includes providing a client device; identifying a viewable area bounding box on the client device; calculating a zoom level for the weather data; determining a frame tile associated with a time frame to render the viewable area; requesting and receiving weather frame data for the frame tiles; loading the weather frame data into a shader; generating a texture to store a weather data value associated with a selected color; loading the GRIB data into map tiles objects; determining a position in a temporal range of animation positions from a beginning frame to an end frame; updating the objects with the position; using bicubic interpolation to produce a GRIB value associated with the position; assigning an output color by comparing the GRIB value against the texture; rendering an animated sequence of the frames; and repeating.

### CROSS-REFERENCE TO RELATED APPLICATION

This application claims the benefit of priority of U.S. provisional application No. 63/579,391, filed Aug. 29, 2023, the contents of which are herein incorporated by reference.

### BACKGROUND OF THE INVENTION

The present invention relates to animation of weather data and, more particularly, to a method for calculating and rendering smooth weather data animations.

Weather data is typically ingested in the form of Edition 2 of GRIdded Binary code (GRIB2) data or network Common Data Form (NETCDF; i.e., satellite data). The data is grid based. When mapping weather data, such as radar precipitation overlays, currently available software typically displays the animation in the style of stop-motion frames where software shows each frame of a weather data animation (such as radar/Next-Generation Radar [NEXRAD]) one at a time. These animations do not present the information that exists in between the stop-motion frames. This form of animation is not smooth, seamless, or easy to understand. While it allows the users to view and see generally what is happening with the weather, it does not show any data in between the main frames and can be slow to load. This is the current industry standard method for rendering and animating weather data, so end users have become accustomed to the information gaps between weather data frames.

The existing systems do not work well for a multitude of reasons. Weather tiles are typically pre-rendered on servers and sent to client devices to be rendered into animations, increasing the amount of data transfer required to render the animation. This process can cause typical animation processes to be blocky or glitch during load. Consider, for example, animation from the Clime® weather application.

Currently available methods that attempt to interpolate data produce inaccurate representations of weather data. Some implementations may attempt to determine the values between weather frames using quadratic interpolation or linear interpolation mixed with OpenGL® Shading Language (GLSL; a C-style language) mipmap (pre-calculated, optimized sequences of images) techniques.

As can be seen, there is a need for smooth, seamless, and easy to understand animation of weather data.

### SUMMARY OF THE INVENTION

In one aspect of the present invention, a method for generating smooth transitions between animated image frames by calculating missing data between the frames is disclosed. The method comprises the following steps. Providing a client device having at least a graphics processing unit (GPU), a memory storage device, and a user interface display; identifying, by the GPU, a viewable area bounding box on the user interface display; calculating, by the GPU, a zoom level for the weather data; determining, by the GPU, a frame tile associated with a time frame to render the viewable area; requesting, by the client device, weather frame data for the frame tiles from a GPU Weather Data Processor (GWDP); receiving, by the client device, the weather frame data; loading, by the GPU, the weather frame data into a shader; generating, by the GPU, a texture to store a weather GRIdded Binary (GRIB) data value associated with a selected color; loading, by the GPU, the weather GRIB data into map tiles objects; determining, by the GPU, a position in a temporal range of animation positions from a beginning frame to an end frame; updating the map tiles objects with the position; calculating a frame for the position; interpolating at least one additional frame of data, by the GPU, with bicubic interpolation to produce a calculated weather data GRIB value associated with the position; assigning, by the GPU, an output color by comparing the calculated weather data GRIB value against the texture; rendering, using the shader, an animated sequence of the frames to the client device; and repeating in an indefinite loop.

The present invention provides a method of bicubic interpolation that allows weather data to be rendered accurately in a smooth and clean way.

US Published patent application US20230065027A1 provides additional information on how to set up a server configuration to process tile data requests and is incorporated by reference in its entirety.

These and other features, aspects and advantages of the present invention will become better understood with reference to the following drawings, description, and claims.

### BRIEF DESCRIPTION OF THE DRAWINGS

FIG. 1A is schematic view of a prior art data tile returned from a graphics processing unit weather data processor;

FIG. 1B is another view thereof, illustrating pixellation;

FIG. 2 is schematic view of the data tile of FIG. 1A with a border added to support edge interpolation;

FIG. 3 is a series of images from an animation process according to an embodiment of the present invention;

FIG. 4 is a schematic diagram of a system according to an embodiment of the present invention;

FIG. 5 is a schematic view illustrating bicubic interpolation of data frame tiles according to the animation process of FIG. 3;

FIG. 6 is another schematic view thereof;

FIG. 7 is an image of a prior art weather data radar tile;

FIG. 8 is an image of a GWDP weather data radar tile according to an embodiment of the present invention; and

FIG. 9 is a flowchart of a method of animating weather data according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “object” refers to a memory object, a chunk of virtual storage containing a group of variables. An object contains data used to perform an animation.

The term “shader” refers to a computer program operated on a graphics processing unit that calculates the levels of light, darkness, and color to render effects of a 3D scene. While a shader focuses on a single pixel at a time, the method disclosed herein simultaneously processes all pixels in a visible data area.

As used herein, the term “texture” refers to high frequency detail, surface texture, or color applied to a computer-generated graphic. A texture reference refers to an index of settings stored on a GPU memory per texture.

“Upsampling” as used herein refers to a data processing technique that increases the sampling rate or spatial resolution of a signal or image by adding new data points between existing ones.

Broadly, one embodiment of the present invention is a method of three-dimensional cubic interpolation to accurately calculate weather data that is not otherwise available from scans or data frames.

This method dramatically improves the technological field of animated rendering of weather data using very accurate bicubic interpolation to calculate missing data between frames across three dimensions (time and X and Y axis). It enables very powerful weather data forecast predictions and animations. X/Y interpolation is not required but is highly encouraged to provide a high-quality rendered animation. This process can even be performed in multiple ways, you can perform X/Y interpolation on each frame and then interpolate the output weather data value between those frames, or you can perform bicubic interpolation across the time axis for the required data points to perform your output X/Y interpolation to determine the weather value. The cubic interpolation across the X&Y axis (whether performed before or after the time interpolation) allows the data to be visualized in a very clean and elegant way. It can provide high quality, highly accurate, and perfectly smooth weather data animations, determining values that otherwise are not available in an extremely accurate way across three dimensions. This results in a flawlessly smooth weather data animation that can be viewed at any speed and still appear very smooth. The method essentially removes the typical understanding of “framed” weather data by calculating the data, providing perfectly smooth weather data animations, whether it is animated slowly or quickly. For instance, 10 frames of weather data used to render a precipitation radar view of the previous hour on 5-minute intervals can be used to calculate the missing information between the data to render and animate a very smooth representation of the weather data.

Different quality bicubic interpolation functions may be used, such as Standard Bicubic Interpolation, Catmull-Rom Spline, B-Spline Interpolation, Lagrange Interpolation, and Hermite Interpolation. These implementations are interchangeable and have very similar results. The user may select one that offers a good compromise of quality and performance.

Note that this very adaptable process can visualize the weather data to different data types, such as precipitation, winds, temperatures, air quality, ultraviolet (UV) index and more.

A different tile projection system may be used than disclosed herein, and the viewable data tiles required may be determined in a different way.

In addition to use in animating weather data, this method may be used to improve the visualization of any dataset that is based on a grid architecture, i.e., to extrapolate and visualize additional data and information. Grid-based charts are used in Geography and Geology, Medical Imaging, Urban Planning, Environmental Science, Astronomy, Oceanography, Engineering, Economics, Remote Sensing, Simulations, and Agriculture. For example, the present subject matter may be used to improve visualization of mapping data from medical scans, e.g., magnetic resonance imaging (MRI) scans, and computer tomography (CT) scans.

Back end-based components related to server-side preparation may derive weather data from many partner sources, consolidate the data, and standardize the data as they become available. For example, all processed data may be standardized to EPSG:4326 (originally referring to European Petroleum Survey Group), a public registry of spatial datasets. Standardizing the data ensures all data forwarded to client requesting devices for use in subsequent steps is consistent and can be rendered using the same technologies and processes.

A GPU Weather Data Processor (GWDP) listens for data requests from client devices. Once a request is received, it executes a kernel operation on the GPU unit to quickly extract the data that is required to satisfy the client's request.

To determine what data is required from the server, the system considers what part of the map the user is looking at via the client device through a software map viewport. For example, the whole software view may be a map that needs to be considered. Identifying the Viewable area Bounding Box (VBBOX) of the user's device (client's viewport) ensures that the data requested is not more than is required to render the complete viewport.

Based on the VBBOX, calculations are performed to determine what zoom level of tile data is to be rendered using a tile system, e.g., a Mercator-based tile system. The required Mercator data tiles are determined and requested from the GWDP server. Extracting any required metadata, the server generates a basic binary file of the data to be loaded into a graphics processing unit (GPU) Weather Data Processor (GWDP). Using the GWDP enables large amounts of data to be processed very quickly to service many thousands of clients concurrently with minimal hardware.

To use the present subject matter, the user does not have to implement the GWDP. Rather, the user may source this data from elsewhere and only process the client-side rendering.

In some embodiments, this method may be implemented without a tile structure or Mercator tile-based data block system. Data packets that match the size of the client software viewport may be generated upon request and the animation interpolation may be performed on that viewport area.

Once data has been loaded into map tiles objects, the animate process may be started, animating the data through shaders, and rendering the output to a screen. The animation progress (x) position is calculated. To achieve the desired animation output, the weather frame tile data required to generate a frame is loaded into a shader process. Weather data tiles may be loaded into animation shaders as textures as they are received. Each tile in an animation has its own geometry and material/shader configuration. Each tile texture returned from the GWDP is loaded into the material/shader uniforms, so the textures are accessible when the shader is executed. The computations iterate for every frame of the animation.

Shaders may be configured in various ways. The method disclosed herein may be performed inside of a single shader, but it is more efficient to separate the process, reducing system load and improving performance.

Once the position in overall animation between beginning and the end has been determined, all objects that are about to be rendered are updated with new information. There are other ways to determine the animation progress (x) position to calculate the animation progress. For example, the animation progress may be based on the current time.

A color texture may be generated for reference inside of the animation shaders. The number of colors may be changed by adjusting the texture size. For example, in some embodiments, the process may be operated with a maximum of 256 colors. Based on color selections, a texture may be generated to store weather GRIdded Binary (GRIB) data value associated colors to be referenced in shader 2 below.

The first shader process may have a render target of, e.g., 32×32 base frame data tiles (variable for different implementations). This shader bicubically interpolates the specific weather data frame values between the original frames for use in a second shader process and calculates a frame for requested animation position. Up until this point, only the “gribValue” is considered.

Now that the first shader has determined the exact weather data frame values, the renderTarget texture may be upsampled using bicubic interpolation in the second shader. A color for the output pixel may then be determined inside of this shader. Output color may be assigned based on calculated weather data GRIB value run against color texture generated earlier.

A switch statement of if-then relationships exists inside the shaders to select the correct source GRIB frame data to use in the cubic calculations. Depending on the syntax supported by the shader environment, the following statement may be used:

switch (frameIndex) {
case 0: gribValue = texture2D(map_0, vUv).r; break;
case 1: gribValue = texture2D(map_1, vUv).r; break;
case 2: gribValue = texture2D(map_2, vUv).r; break;
case 3: gribValue = texture2D(map_3, vUv).r; break;
case 4: gribValue = texture2D(map_4, vUv).r; break;
case 5: gribValue = texture2D(map_5, vUv).r; break;
case 6: gribValue = texture2D(map_6, vUv).r; break;
case 7: gribValue = texture2D(map_7, vUv).r; break;
case 8: gribValue = texture2D(map_8, vUv).r; break;
case 9: gribValue = texture2D(map_9, vUv).r; break;
case 10: gribValue = texture2D(map_10, vUv).r; break;
}
Return gribValue;

The shaders may be run from the beginning of the animation process for every frame, updating the animation×progress position, and rendering in an indefinite loop.

To output a final animation, final pixel colors can be determined in various ways. In some embodiments, a color texture may be pre-generated to make color searches very fast inside of the shaders process. In other embodiments, the output color may be determined by considering the weather data value (gribValue) inside of the shaders process. The process by which the output pixel color may be calculated is the same for how to get the weather data on to the client device. This is interchangeable and may have little to no effect on the desired result.

The data transfer of the present method is inherently faster than currently commercially available weather animation methods because lower resolution data can be transferred from the server to the client device.

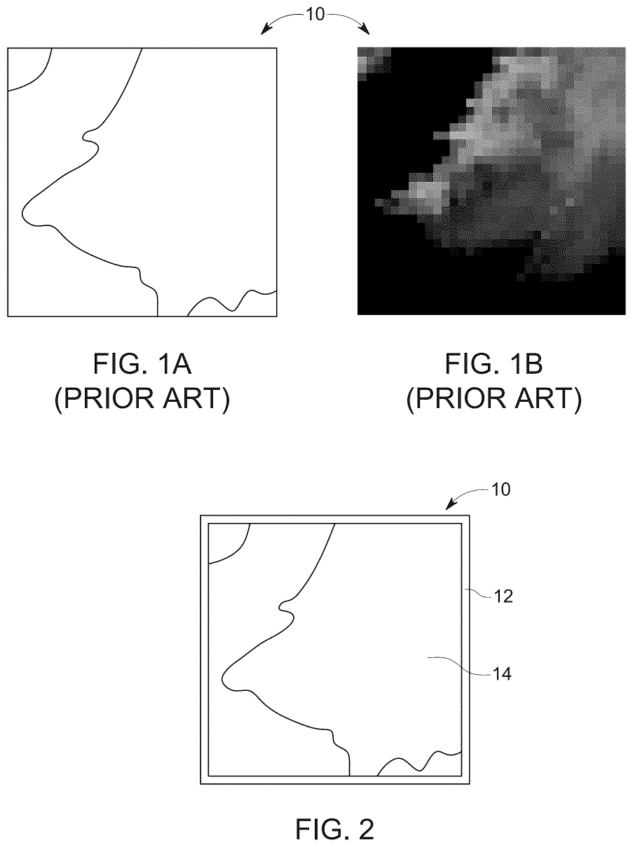

Referring to FIGS. 1A, 1B, and 2-9, FIG. 1B illustrates a pixelated prior art data tile 10 obtained from a GWDP and having a visible data area 14. FIG. 1A is a schematic view of the data tile of FIG. 1B. Each pixel in FIG. 1B is a GRIB data value.

As shown in FIG. 2, a border 12 (e.g., 1 pixel at the edge) added around the data tile 10 of FIG. 1A is used for interpolation in a method according to an embodiment of the present invention. This additional data enables a seamless appearance when viewing adjacent tiles.

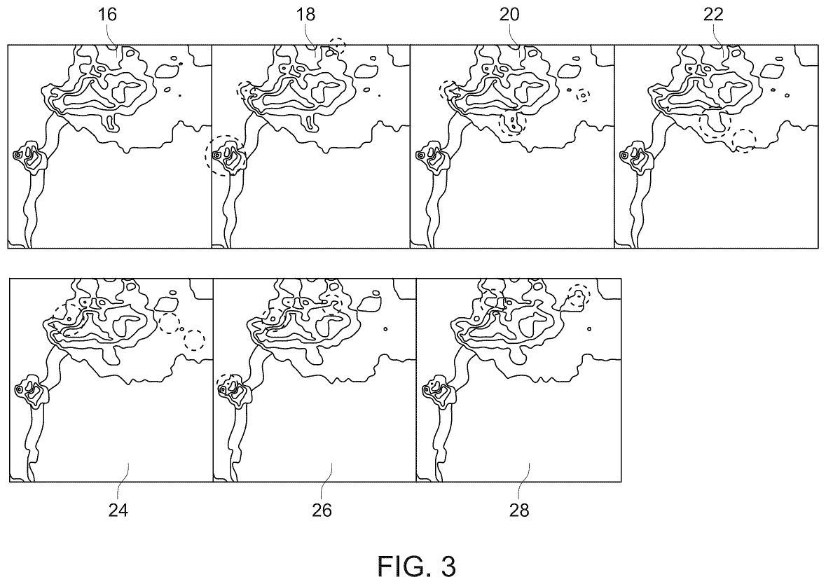

FIG. 3 illustrates a smooth animation output with a series of animation tiles 16, 18, 20, 22, 24, 26, and 28 that may be obtained according to the inventive method. Broken line circles highlight features of interest.

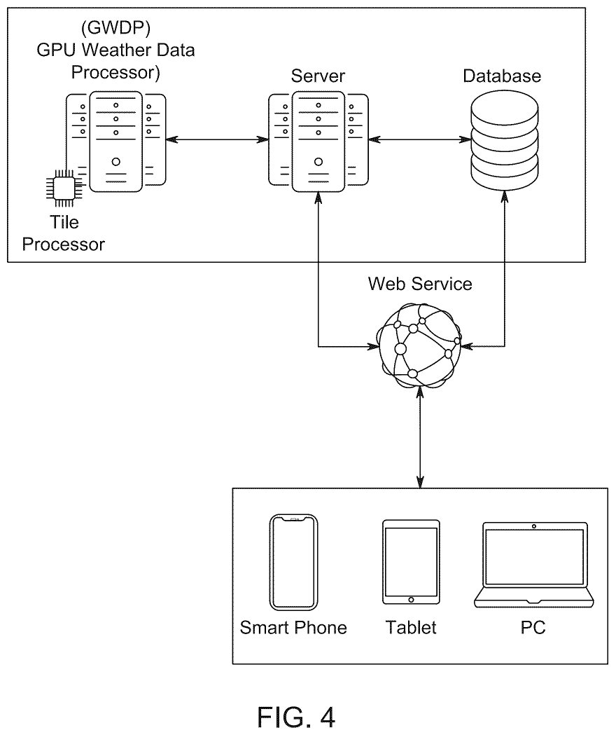

A system according to an embodiment of the present invention is shown in FIG. 4. Client devices (smart phone, tablet, PC) interact with a GWDP with a tile processor, a server, and a database via a web service. Upon request by a client device, the GWDP obtains data from the server and database and animates and renders the data using the tile processor, delivering the final animation to the client device.

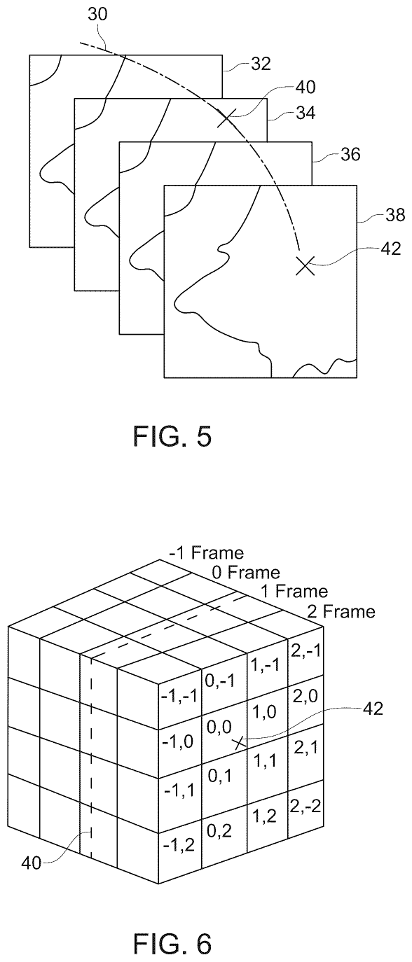

FIG. 5 illustrates use of a bicubic interpolation spline 30 running through a series of weather data frame tiles 32, 34, 36, 38 to calculate new frames of data. The spline 30 passes through a target 40 in 3D space across time to obtain a 2D target lookup location 42 for output of a pixel.

FIG. 6 is a 3D representation of data points used by a method according to an embodiment of the present invention using bicubic interpolation on weather data as shown in FIG. 5. Splines running across each axis are used to calculate the value of a point in a center unit of the cube. In FIG. 6, the axis indicated by −1 Frame, 0 Frame, 1 Frame, 2 Frame is a measure of time and shows the position of the interpolated frame 40 within the animation. The vertical plane having coordinates represents 2-dimensional location data. Coordinate 42 indicates the location of the animation for the client device.

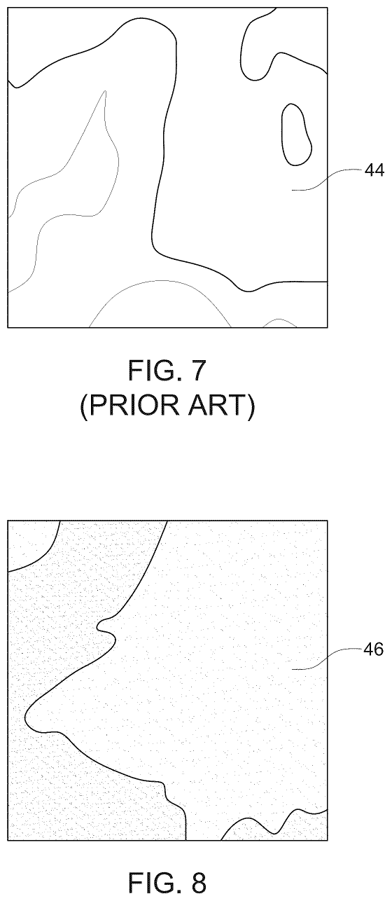

FIGS. 7 and 8 show the unexpected reduction in data necessary to render high quality, smooth weather animations using the present method as compared to a prior art animation. FIG. 7 illustrates a prior art weather data radar tile 44, 256×256 pixels for an average size of 53.4 KB, which would require an average total size of 9600 KB for 18 tiles to render a single frame on a client device of a request for 10 frames. FIG. 8 shows a GWDP weather data radar tile 46 according to an embodiment of the present invention, 32×32 pixels, for an average size of 2.0 KB. For the same request, the GWDP weather data radar tile illustrated in FIG. 8 only requires an average total size of 360 KB. This results in the amount of data transfer required for our higher quality, more accurate and smoother weather overlay animation being typically less than 5% of what is required by industry standard weather overlay animation.

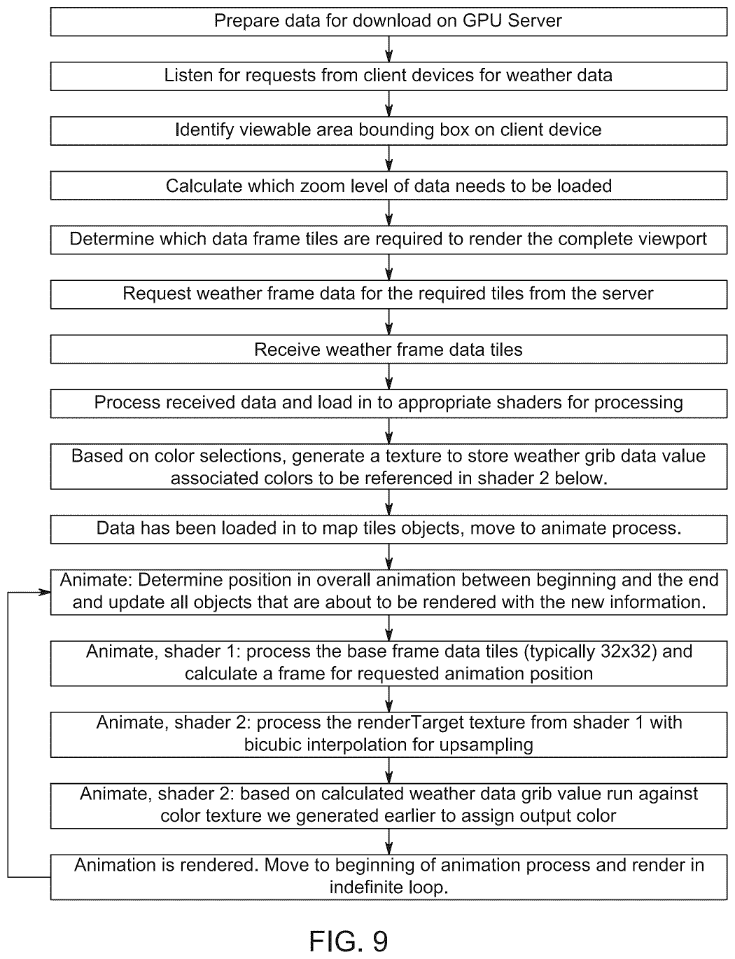

FIG. 9 illustrates a method of animating and rendering weather data according to an embodiment of the present invention, including the following steps. A GPU server prepares data for download by collecting data from disparate sources, concatenating the data, and storing it in memory. See, for example, U.S. Pat. No. 11,978,160B2 to Curtis, the contents of which are incorporated by reference. The server listens for requests from client devices for weather data. A client device including at least a GPU, a memory, and a display identifies a bounding box around a viewable area on the client device's display. The client device processor calculates which zoom level of data needs to be loaded for animation and determines which data frame tiles (i.e., time sequence) are required to render the complete viewport. The client device then requests weather frame data for the required tiles from the GPU server. The GPU server makes the weather frame data tiles available for download by the client device. The client device receives the weather frame data, stores the data on the client device memory, processes the data, and loads the data into a shader for processing. The shader (sometimes referred to herein as Shader 1) generates a texture to store colors associated with weather GRIB data values to memory. Once the downloaded, processed data has been loaded into map tiles memory objects, animation may be initiated by determining a target position (i.e., time) in an overall animation between a beginning and an ending point. The client device updates all objects to be rendered with new information (i.e., x_anim_pos in Example 1, below; x_anim_pos changes for every frame of the animation). Shader 1 processes the raw data or base frame data tiles (typically 32×32) received from a server and calculates a frame for a requested animation position (i.e., between stored frames). The animation process may begin again and the GPU may render the animation in an indefinite loop.

In some embodiments, the user may select colors or a color theme for the display. Shader 1 may generate the texture based on the user's color selections.

In some embodiments, a second shader (sometimes referred to herein as Shader 2) may be used. The texture generated by Shader 1 may be referenced in (used by) shader 2. Shader 2 animation includes processing the renderTarget texture from shader 1 with bicubic interpolation for upsampling. Based on a calculated weather data GRIB value run against the color texture generated earlier, Shader 2 assigns an output color and renders the animation on the client device display.

### Example 1

Fragment shader code (shader 1) according to an embodiment of the present invention is shown below. Shader 1 performs interpolation across time.

```
varying vec2 vUv;
uniform sampler2D map_0;
uniform sampler2D map_1;
uniform sampler2D map_2;
uniform sampler2D map_3;
uniform sampler2D map_4;
uniform sampler2D map_5;
uniform sampler2D map_6;
uniform sampler2D map_7;
uniform sampler2D map_8;
uniform sampler2D map_9;
uniform sampler2D map_10;
uniform sampler2D map_11;
uniform float x_anim_pos;
float cubicInterpolate(float p0, float p1, float p2, float p3, float t) {
float t2 = t * t;
float t3 = t2 * t;
float a = −0.5 * p0 + 1.5 * p1 − 1.5 * p2 + 0.5 * p3;
float b = p0 − 2.5 * p1 + 2.0 * p2 − 0.5 * p3;
float c = −0.5 * p0 + 0.5 * p2;
float d = p1;
return a * t3 + b * t2 + c * t + d;
}
lowp float getFrameGribValue(int framIndex, vec2 vUv) {
lowp float gribValue;
if (frameIndex == 0) {
gribValue = texture2D(map_0, vUv).r;
else if (frameIndex == 1) {
gribValue = texture2D(map_1, vUv).r;
else if (frameIndex == 2) {
gribValue = texture2D(map_2, vUv).r;
else if (frameIndex == 3) {
gribValue = texture2D(map_3, vUv).r;
else if (frameIndex == 4) {
gribValue = texture2D(map_4, vUv).r;
else if (frameIndex == 5) {
gribValue = texture2D(map_5, vUv).r;
else if (frameIndex == 6) {
gribValue = texture2D(map_6, vUv).r;
else if (frameIndex == 7) {
gribValue = texture2D(map_7, vUv).r;
else if (frameIndex == 8) {
gribValue = texture2D(map_8, vUv).r;
else if (frameIndex == 9) {
gribValue = texture2D(map_9, vUv).r;
else if (frameIndex == 10) {
gribValue = texture2D(map_10, vUv).r;
}
Return gribValue;
}
lowp float getInterpolatedFrameGribValue(float cubix_x_animation_position, int
  frame_index, vec2 uv) {
lowp float gb0 = getFrameGribValue(frame_index − 1, uv);
lowp float gb0 = getFrameGribValue(frame_index, uv);
lowp float gb0 = getFrameGribValue(frame_index + 1, uv);
lowp float gb0 = getFrameGribValue(frame_index + 2, uv);
return cubicInterpolate(gb0, gb1, gb2, gb3, cubic_x_animation_position);
}
void main( ) {
float qty_frames = 10.0;
int base_frame_index = in(floor(x_anim_pos * (qty_frames)));
lowp float cubic_x_animation_position = x_anim_pos * qty_frames −
  float(base_frame_index);
lowp float gribValue = getINterpolatedFrameGribValue(cubic_x_animation_position,
  base_frame_index, vUv);
gl_FragColor = vec4(gribValue, 0.0, 0.0, 1.0);
```

### Example 2

Fragment shader code (shader 2) according to an embodiment of the present invention is shown below. Shader 2 interpolates across X-Y axes, i.e., location.

lowp vec4 result = vec4(0.0, 0.0, 0.0, 0.0);
lowp vec2 texSize − vec2(32.0);
lowp Float texSamples[4];
LowD vec2 gribTexSize − vec2(32.0);
lowp vec2 data_border = vec2(1.0);
lowp vec2 dataSize = vec2(gribTexSize.x − data border.x * 2.0, gribTexSize.y −
data_border.y * 2.0);
lowp vec2 gribTexCoord = vUv * dataSize − 0.5;
for (int y = −1; y <= 2; y++) {
lowp float x_values [4];
for (int x = −1; x <= 2; x++) {
// determine updated uv considering offset and texSize
Lowp vec2 offset − vec2(float(x) + data_border.x, float(y) + data border. y);
lowp vec2 texturePos = floor (gribTexCoord + offset + 0.5) / gribTexSize;
x_values [x + 1] = texture2D(grib_value_map, texturePos).r;
}
texSamples[y + 1] = cubicInterpolate(x_values[0], x_values[1], X_values[2],
X_values[3], fract(gribTexCoord.x + 0.5));
}
lowp float gribValue = cubicInterpolate(texSamples[0], texSamples[1],
texSamples[2], texSamples[3], fract(gribTexCoord.y + 0.5)) * 255.0;
float divisionResult = gribValue / 16.0;
float color_x = fract(divisionResult) * 16.0;
Float color_y = floor(divisionResult) + 1.0;
vec2 texCoord = vec2(color_x, 16.0 − color_y) / 16.0;
result = texture2D(color_texture, texCoord);
result.a *= opacity;
gl_FragColor = result;

It should be understood, of course, that the foregoing relates to exemplary embodiments of the invention and that modifications may be made without departing from the spirit and scope of the invention as set forth in the following claims.

What is claimed is:

1. A method for generating smooth transitions between animated data frames, comprising:
(a) providing a client device having at least a processor, a memory storage device, and a user interface display;
(b) identifying, by the processor, a viewable area bounding box on the user interface display;
(c) determining, by the processor, frame data within a selected timeframe to render the viewable area;
(d) requesting, by the client device, the frame data from a data source;
(e) receiving, by the client device, the frame data;
(f) loading, by the processor, the frame data into tile objects;
(g) determining, by the processor, a transition position in a temporal range of animation positions from a beginning frame to an end frame;
(h) interpolating, by the processor, at least one additional frame of data associated with the transition position utilizing bicubic interpolation;
(i) rendering, using a shader, an animated sequence of the data frames including the beginning frame, the at least one additional frame of data, and the end frame to the client device; and
(j) repeating (g) through (i) in a loop.

2. The method of claim 1, further comprising generating, by the processor, a texture to store color data; and
assigning, by the processor, an output color to the one additional frame referencing the texture.

3. The method of claim 2, further comprising a second shader, wherein the second shader interpolates the frame data based on location and renders the animated sequence referencing the texture.

4. The method of claim 3, wherein the interpolating is performed based on the location before the temporal range.

5. The method of claim 3, wherein the interpolating is performed on the temporal range before the location.

6. The method of claim 1, further comprising calculating, by the processor, a zoom level for image data for the viewable area before the requesting the frame data from the data source.

7. The method of claim 1, wherein the step of interpolating utilizes a calculation method selected from the group consisting of: Catmull-Rom Spline Interpolation, B-Spline Interpolation, Lagrange Interpolation, Hermite Interpolation, and any combination thereof.

8. The method of claim 1, further comprising listening, by the data source, for the request.

9. A non-transitory computer-readable medium with instructions stored thereon, that when executed by a processor, performs the steps of claim 1.

10. A system generating smooth transitions between animated image frames by calculating missing data between the frames, comprising:
client device having at least a processor, a memory storage device, and a user interface display; and
a data source;
wherein the client device is operative to perform the steps of claim 1.
